(19) United States
(12) Patent Application Publication
(10) Pub. No.: US 2026/0197293 A1
(43) Pub. Date: Jul. 9, 2026

(54) Auxiliary Network Attachments for Containerized Workloads

(71) Applicant: Oracle International Corporation, Redwood Shores, CA (US)

(72) Inventors: Abhinav Mishra, Livermore, CA (US); Karl H. Heiss, Raleigh, NC (US); Kristen F. Jacobs, Bristol (GB); Olgierd Pieczul, Castleknock (IE)

(21) Appl. No.: 19/014,979

(22) Filed: Jan. 9, 2025

(51) Int. Cl. H04L 61/45; G06F 9/445

(52) U.S. Cl. CPC H04L 61/45; G06F 9/44526

(57) ABSTRACT

A system for instantiating distinct network namespaces for each container within a pod is provided. The system includes one or more computer-readable non-transitory storage media embodying software that is operable when executed to instantiate a first network namespace for a pod, determine whether a pod specification includes an indication of an intent to create a second network namespace for the pod, and, responsive to determining that the pod specification includes the indication of the intent to create the second network namespace, instantiate the second network namespace for the pod. The pod includes a logical unit configured to execute one or more containers, in which the pod is managed by a container orchestration system, and the pod specification includes a file including one or more attributes of the pod.

### TECHNICAL FIELD

This disclosure relates generally to containerized workloads, and, more specifically to auxiliary network attachments for containerized workloads.

### BACKGROUND

A container orchestration system provides a runtime for containerized workloads and services. Examples of container orchestration systems can include Kubernetes, Docker Swarm, and others. While this specification focuses on Kubernetes, other container orchestration systems may be used. In one example, a container may include a software package that may be a self-contained execution environment. For example, the container may include one or more programs to be executed and the dependencies of the program, such as programming language runtimes and libraries. Similarly, a pod is a group of one or more containers. Containers in the same pod are co-located, which means they execute on the same node. A network namespace is a mechanism for isolating groups of resources within a single cluster. For example, a network namespace provides an entire network stack, including its own routes (routing tables), firewall rules, and network devices. A network namespace also provides a scope for unique names; names of resources may be unique within a network namespace, but not across network namespaces. Conventionally, container orchestration systems such as Kubernetes implement at most a single network namespace per pod.

In some instances, to host more complex containerized applications on Kubernetes, there is a need to securely connect multiple network interfaces to a single pod. These different interfaces could belong to different entities within the cloud with varying trust levels and overlapping classless inter-domain routing (CIDR) blocks. One problem here is the common access to the network stack of a single network namespace between the network interfaces. A network interface may perform malicious acts, thereby affecting the pod and the other interfaces within the network namespace. Another problem here is the risk of address conflicts. Packets may be routed incorrectly or dropped, resulting in miscommunications.

### BRIEF DESCRIPTION OF THE DRAWINGS

FIGS. 1A and 1B illustrate a computing node cluster (e.g., Kubernetes cluster) including one or more components on a control plane node and at least one worker node of a Kubernetes cluster, respectively, according to at least one embodiment.

FIG. 2A illustrates a schematic diagram of a pod executing on a worker node including a container within a default network namespace and a container within an auxiliary network namespace, according to at least one embodiment.

FIG. 2B illustrates a flowchart of a method for receiving a user request to create a network interface custom resource within an auxiliary network namespace and creating the customer network interface within the auxiliary network namespace, according to at least one embodiment.

FIG. 2C illustrates a flowchart of a method for executing a container network interface (CNI) plugin that accesses and searches a pod specification, locates appropriate pod annotations, and instantiates and configures an auxiliary network namespace based on the located pod annotations, according to at least one embodiment.

FIG. 3A illustrates a schematic diagram of a pod executing on a worker node including a container within a default network namespace and a container within an auxiliary network namespace and a resolver configuration file that runs within the auxiliary network namespace, according to at least one embodiment.

FIG. 3B illustrates a flowchart of a method for executing a container runtime wrapper to instantiate and configure a container to be within an auxiliary network namespace, according to at least one embodiment.

FIG. 4A illustrates a schematic diagram of a proxy container that is instantiated within a default network namespace of the pod for performing health checks of a respective container instantiated within an auxiliary network namespace, according to at least one embodiment.

FIG. 4B illustrates a flowchart of a method for instantiating a proxy container within a default network namespace, and further executing the proxy container to perform one or more health checks on a container within an auxiliary network namespace, according to at least one embodiment.

FIG. 5A illustrates a schematic diagram of a pod, in which data packets are routed to and from a container within an auxiliary network namespace of the pod, according to at least one embodiment.

FIG. 5B illustrates a schematic diagram of a pod, in which data packets are routed to and from a container within a default network namespace of the pod, according to at least one embodiment.

FIG. 5C illustrates a schematic diagram of a pod, in which data packets are routed to and from a host process on a host network namespace of the pod, according to at least one embodiment.

FIG. 5D illustrates a schematic diagram of the pod, in which data packets are routed from an auxiliary network namespace of the pod to the default network namespace of the pod, according to at least one embodiment.

FIG. 5E illustrates a flowchart of a method for receiving data packets and routing the data packets based on whether the data packets are received at an auxiliary network namespace of a pod, according to at least one embodiment.

FIG. 5F illustrates a flowchart of a method for transmitting one or more data packets from a container in an auxiliary network namespace of a pod, according to at least one embodiment.

FIG. 6 is a block diagram illustrating a pattern of an IaaS architecture, according to at least one embodiment.

FIG. 7 is a block diagram illustrating another pattern of an IaaS architecture, according to at least one embodiment.

FIG. 8 is a block diagram illustrating another pattern of an IaaS architecture, according to at least one embodiment.

FIG. 9 is a block diagram illustrating another pattern of an IaaS architecture, according to at least one embodiment.

FIG. 10 illustrates an example computer system, in which various embodiments may be implemented.

### DESCRIPTION OF EXAMPLE EMBODIMENTS

### 1. Overview of Example Embodiments

According to an embodiment, provided is one or more computer-readable non-transitory storage media embodying software that is operable when executed to instantiate a first network namespace for a pod, determine whether a pod specification includes an indication of an intent to create a second network namespace for the pod, and, responsive to determining that the pod specification includes the indication of the intent to create the second network namespace, instantiate the second network namespace for the pod. The pod includes a logical unit configured to execute one or more containers, the pod being managed by a container orchestration system, and the pod specification comprising a file including one or more attributes of the pod.

In particular embodiments, each of the first network namespace and the second network namespace comprises its own network stack, including its own routing table. The first network namespace is a default network namespace and the second network namespace is an auxiliary network namespace. In particular embodiments, the one or more computer-readable non-transitory storage media embodying software that is further operable when executed to instantiate the first network namespace and the second network namespace for the pod during creation of the pod. In particular embodiments, the one or more computer-readable non-transitory storage media embodying software that is further operable when executed to instantiate the first network namespace based on a first CNI plugin, and further to instantiate the second network namespace is executed based on a second CNI plugin.

In particular embodiments, a virtual ethernet pair (veth) interconnects the first network namespace and a host namespace of a host executing the pod. In particular embodiments, an auxiliary network attachment interconnects the second network namespace and an external network. In particular embodiments, an auxiliary network attachment interconnects the second network namespace and an external network without going through a host namespace of a host executing the pod. In particular embodiments, a transmission control protocol/internet protocol (TCP/IP) connection does not connect the first network namespace and the second network namespace.

According to another embodiment, one or more computer-readable non-transitory storage media embodying software and one or more processors coupled to the one or more computer-readable non-transitory storage media. The one or more processors are configured to execute the software to instantiate a first network namespace for a pod, determine whether a pod specification includes an indication of an intent to create a second network namespace for the pod, and responsive to determining that the pod specification includes the indication of the intent to create the second network namespace, instantiate the second network namespace for the pod. The pod includes a logical unit configured to execute one or more containers, the pod being managed by a container orchestration system, and the pod specification comprising a file including one or more attributes of the pod.

According to another embodiment, provided is one or more computer-readable non-transitory storage media embodying software that is operable when executed to create a first set of domain name resolution settings for a container to be created in a pod. The first set of domain name resolution settings are associated with a default network namespace of the pod. The one or more computer-readable non-transitory storage media embodying software that is further operable when executed to determine whether the container is destined for an auxiliary network namespace of the pod, and responsive to determining that the container is destined for the auxiliary network namespace of pod, to associate the container with a second set of domain name resolution settings rather than the first set of domain name resolution settings. The second set of domain name resolution settings are associated with the auxiliary network namespace. The pod includes a logical unit configured to execute one or more containers including the container, the pod being managed by a container orchestration system.

In particular embodiments, the one or more computer-readable non-transitory storage media embodying software that is further operable when executed to associate the container with the second set of domain name resolution settings by creating a new resolution configuration file including the second set of domain name resolution settings, and further updating a configuration file of the container to replace a first path to an existing resolution configuration file including the first set of domain resolution settings to a second path to the new resolution configuration file including the second set of domain resolution settings.

In particular embodiments, the second set of domain resolution settings indicates a domain name server (DNS) that is configured to perform a domain name resolution for an auxiliary network attachment interconnecting the auxiliary network namespace and an external network. In particular embodiments, subsequent to associating the container with the second set of domain name resolution settings, a domain name resolution for packets between the container and a second container in the default network namespace cannot be performed. In particular embodiments, subsequent to associating the container with the second set of domain name resolution settings, a domain name resolution for packets between the container and a host process executing on the host executing the pod cannot be performed.

Technical advantages of this disclosure may include one or more of the following. In contrast to conventional logical Kubernetes pod architectures in which all containers within the Kubernetes pod share the same network namespace, certain disclosed embodiments provide separate and distinct network namespaces (e.g., a default network namespace and an auxiliary network namespace) within a single Kubernetes pod. For example, in accordance with the presently disclosed embodiments, a container orchestration system provides more than one network namespace per Kubernetes pod, such that container(s) of the Kubernetes pod are in one namespace, and other container(s) of the Kubernetes pod are in a separate and distinct network namespace. In this way, different network interfaces may be isolated and connected to different network namespaces. Specifically, by providing separate and distinct network namespaces (e.g., default network namespace and auxiliary network namespace) within a single the Kubernetes pod, the present embodiments may provide a secure execution context for each respective container within the Kubernetes pod.

Additionally, in accordance with the presently disclosed embodiments, each network namespace may be connected to different network interfaces, such that a network interface connected to one network namespace has no access to resources (e.g., pods, network interfaces, etc.) in another network namespace within the same Kubernetes pod. Lastly, in accordance with the presently disclosed embodiments, for conducting health checks on a container in the auxiliary network namespace, a proxy container is executed in the default network namespace of the Kubernetes pod. For example, responsive to receiving a health check request from a health check system, the proxy container sends a health check request to the corresponding container in the auxiliary network namespace. The proxy container then sends a response back to the health check system based on the response of the container in the auxiliary network namespace.

Other technical advantages will be readily apparent to one skilled in the art from the following figures, descriptions, and claims. Moreover, while specific advantages have been enumerated above, various embodiments may include all, some, or none of the enumerated advantages.

As used herein, a “container orchestration system” may refer to a system that provides a runtime for containerized workloads and services. Examples of container orchestration systems can include Kubernetes, Docker Swarm, etc.

As used herein, a “container” may refer to a software package that is a self-contained execution environment. The “container” includes (a) one or more programs to be executed and (b) the dependencies of the program, such as programming language runtimes and libraries.

As used herein, a “pod” may refer to a group of one or more containers. Containers in the same pod are co-located, which means they execute on the same node.

As used herein, a “node” may refer to a computing host (e.g., a bare metal machine or a virtual machine) that executes one or more containers. The “node” provides a set of computing resources (e.g., CPU resources and RAM resources).

As used herein, a “cluster” may refer to a group of one or more nodes.

As used herein, a “network namespace” may refer to a mechanism for isolating groups of resources within a single cluster. The “network namespace” provides an entire network stack, including its own routes (routing tables), firewall rules, and network devices. The “network namespace” also provides a scope for unique names; names of resources need to be unique within a network namespace, but not across network namespaces. Conventionally, container orchestration systems, such as Kubernetes implement at most a single network namespace per pod.

As used herein, a “container runtime” may refer to a software component responsible for running containers. The “container runtime” handles low-level operations required to start, stop, and manage containers.

As used herein, a “wrapper” around a container runtime utilizes the container runtime for running containers but provides additional and/or customized features for container lifecycle management. For example, different users of a particular container runtime may add and/or write their own wrappers.

As used herein, a “container runtime configuration file” (e.g., runc config. json) specifies settings and parameters for running a container. Each container is associated with its own “container runtime configuration file.” For example, when creating a container, the container runtime reads the configuration file to set up the container environment according to the specified parameters. The container runtime may put the container in a specified namespace according to the configuration file.

As used herein, a “resolution configuration file” or a “resolver configuration file” (e.g., resolv. conf) may refer to a file that specifies how domain names should be resolved to internet protocol (IP) addresses. Nodes, pods, clusters, and/or containers may each have their own resolution configuration file. When a container is created, a container runtime may generate a resolution configuration file for the container based on the node's or the cluster's DNS settings.

As used herein, a “CNI plugin” may refer to a software plugin configures network interfaces for containers. The “CNI plugin” configures network namespaces, assigns IP addresses, and sets up routes. The “CNI plugin” is installed and configured on each node. The “CNI plugin” is not part of a container runtime, but it is invoked by the container runtime during specific lifecycle events to handle networking tasks. For example, a container runtime may invoke a “CNI plugin” as part of container creation to configure the container's network.

As used herein, a “network interface” may refer to a point of interconnection between a computer and a private or public network. A network interface is generally a network interface card (NIC) but does not have to have a physical form. In certain embodiments, the “network interface” may be implemented in software or as a piece of software simulating a network interface.

### 2. Kubernetes Cluster, Control Plane Node, and Worker Node System Overview

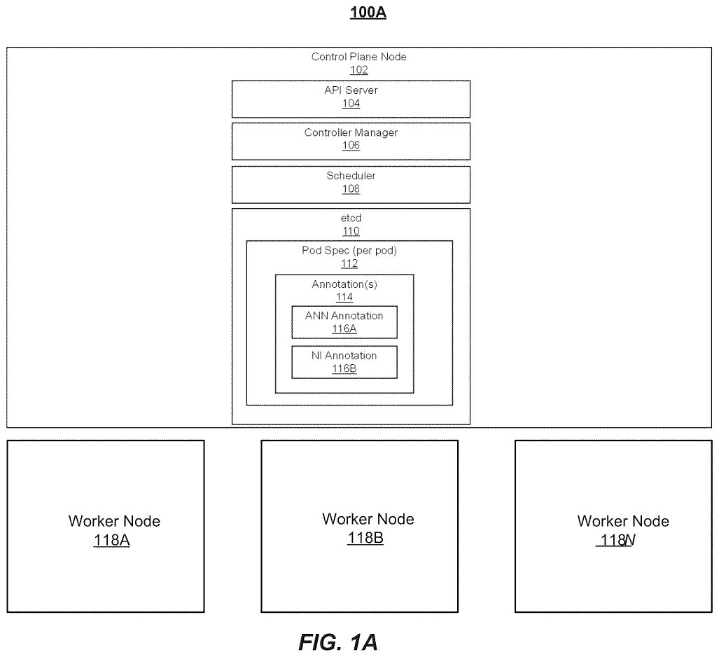

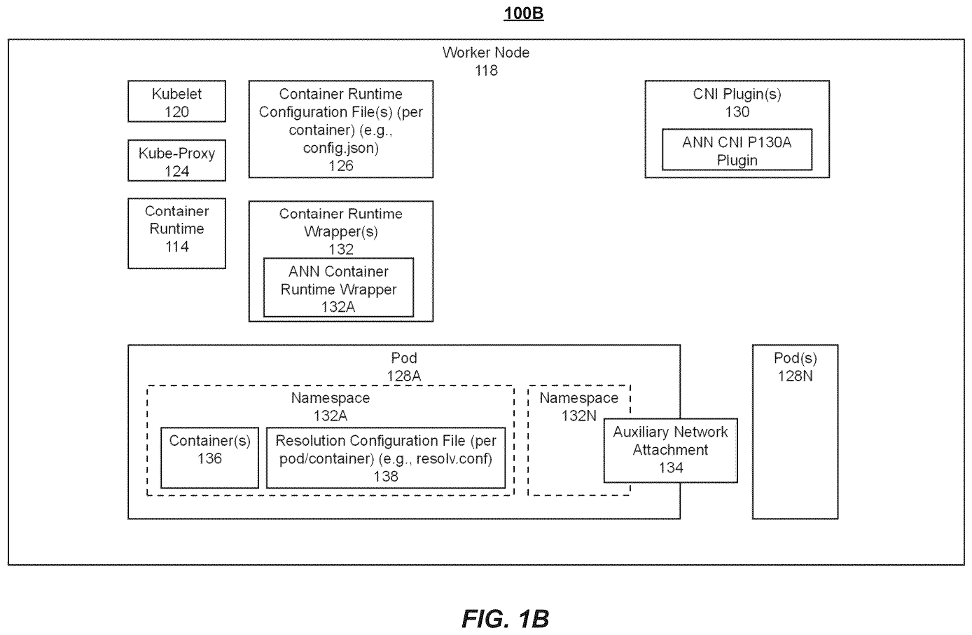

FIG. 1A illustrates a computing node cluster 100A including a control plane node 102 and one or more worker nodes 118A-118N (where 118N represents any suitable integer), in accordance with one or more embodiments of the present disclosure. FIG. 1B illustrates a worker node 100B, also referred to as worker node 118, in accordance with one or more embodiments of the present disclosure. As depicted, in one embodiment, the computing node cluster 100A may include a Kubernetes cluster. For example, the computing node cluster 100A (e.g., Kubernetes cluster) may include a number of computing nodes (one or more physical or virtual machines running applications), such as a control plane node 102, a worker node 118A, a worker node 118B, and so on to worker node 118N. In particular embodiments, the computing capacity (e.g., the number of central processing units (CPUs) and amount of memory) of each of the control plane node 102, the worker node 118A, the worker node 118B, and so on to worker node 118N may be defined at the time of instantiation of each computing node.

In particular embodiments, as further depicted, the control plane node 102 may include a number of components, such as an application programming interface (API) server 104, a controller manager 106, a scheduler 108, and an etcd 110. For example, the API server 104 (e.g., kube-apiserver) may be utilized to support Kubernetes API operations requested from the Kubernetes command line tool (kubectl) and/or other command line tools, as well as from direct representational state transfer (REST) calls. The controller manager 106 (e.g., kube-controller-manager) may be utilized to manage various Kubernetes controller components (e.g., replication controller, endpoints controller, namespace controller, serviceaccounts controller, and so forth). The scheduler 108 (e.g., kube-scheduler) may be utilized to control where in the cluster to execute jobs or other similar computing tasks.

In particular embodiments, the etcd 110 may be utilized to store configuration data for the computing node cluster 100A (e.g., Kubernetes cluster). For example, as further depicted by FIG. 1A, the etcd 110 may include a pod specification 112, which may include one or more annotations 114. Different types of annotations 114 may be used. In particular embodiments, an auxiliary network namespace (ANN) annotation 116A indicates an intent to instantiate multiple network namespaces for a single pod. Additionally, a network interface (NI) annotation 116B designates an auxiliary network attachment for an auxiliary network.

Referring to FIG. 1B, in particular embodiments, the worker node 118 may correspond to one of the worker node 118A, the worker node 118B, or so on to worker node 118N. In particular embodiments, the worker node 118 may include a cluster data plane, and the worker node 118 may be further utilized to execute any containerized applications deployed in the computing node cluster 100A (e.g., Kubernetes cluster). For example, in one embodiment, the worker node 118 may execute a number of processes, such as a kubelet 120 to communicate with the control plane node 102; a kube-proxy 124 to maintain networking rules and configurations; and a container runtime 122 for running containers, including handling low-level operations required to start, stop, and manage containers. In particular embodiments, the worker node 118 may include pod 128A and so on to pod 128N (where 128N represents any suitable integer) grouped into a single logical set known as a “service.” For example, in one embodiment, pod 128A and so on to pod 128N may be suitable for providing a same or similar functionality.

In particular embodiments, as further depicted by FIG. 1B, the pod 128A is a single logical unit that may be utilized for facilitating management and discovery of one or more containerized applications executing on the worker node 118. In accordance with the presently disclosed embodiments, the pod 128A may include separate and distinct network namespaces 132A (e.g., a default network namespace) and 132B (e.g., an auxiliary network namespace). A set of containers 136 may operate in network namespace 132A, while a separate set of containers (not illustrated) may operate in network namespace 132B. Thus, in accordance with the presently disclosed embodiments, containers in different network namespaces 132A, 132B may be isolated from each other. In certain embodiments, the pod 128A includes an auxiliary network attachment 134. The auxiliary network attachment 134 is a network interface between a network namespace 132B and a customer network (e.g., a virtual cloud network (VCN)). The auxiliary network attachment 134 is attached to the network namespace 132B, but not to the network namespace 132A. The auxiliary network attachment 134 may also be referred to as a “customer interface.”

In particular embodiments, as further depicted by FIG. 1B, at pod 128A instantiation time, the worker node 118 may execute one or more CNI plugins 130. Various types of CNI plugins 130 may be used. In an embodiment, an ANN CNI plugin 130A is configured to access and search the pod specification 112 (as depicted in FIG. 1A), locate (if any) an ANN annotation 116A (as depicted in FIG. 1A) and an NI annotation 116B (as depicted in FIG. 1A0, and instantiate and configure the network namespace 132B based on the ANN annotation 116A and the NI annotation 116B.

Similarly, at container time 122, the worker node 118 may execute one or more container runtime wrappers 133. Various types of container runtime wrappers 133 may be used. In an embodiment, an auxiliary network namespace container runtime wrapper 133A is configured to configure the container to be within the network namespace 132B (e.g., an auxiliary network namespace). The auxiliary network namespace container runtime wrapper 133A updates a container runtime configuration file 126 (a) to indicate that the container is within the network namespace 132B (as opposed to the network namespace 132A), and (b) to indicate that a new resolution configuration file is to be used for the container; wherein the new resolution configuration file is created by the ANN container runtime wrapper and specifies domain name resolutions for the network namespace 132B.

### 3. Instantiating a Pod Including a Default Network Namespace and an Auxiliary Network Namespace, Configuring the Auxiliary Network Namespace within the Pod, and Creating a Customer Network Interface within the Auxiliary Network Namespace

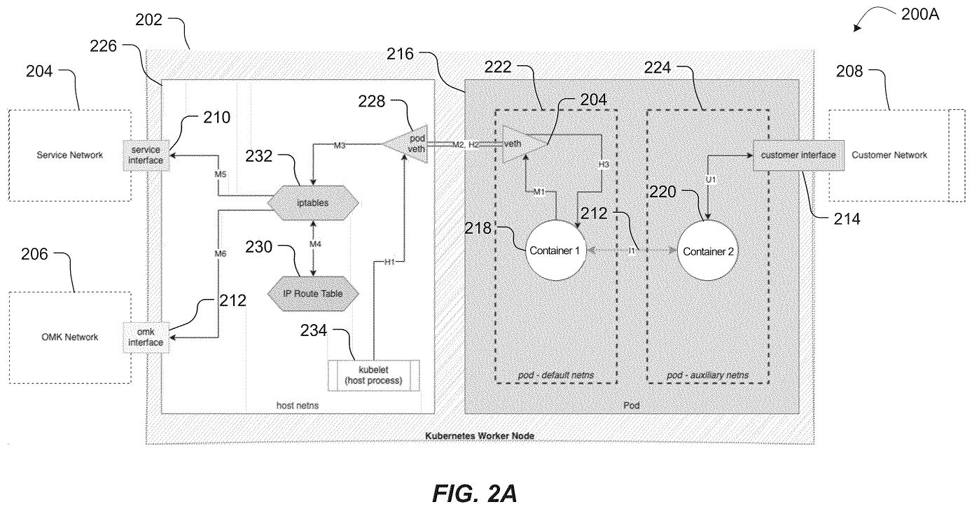

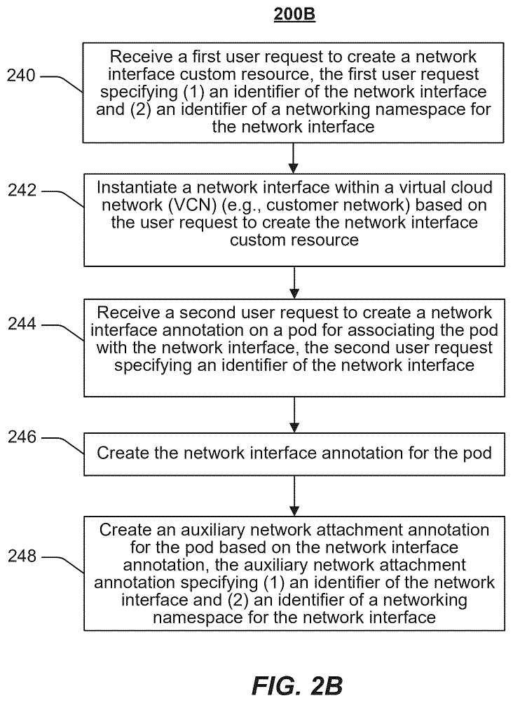

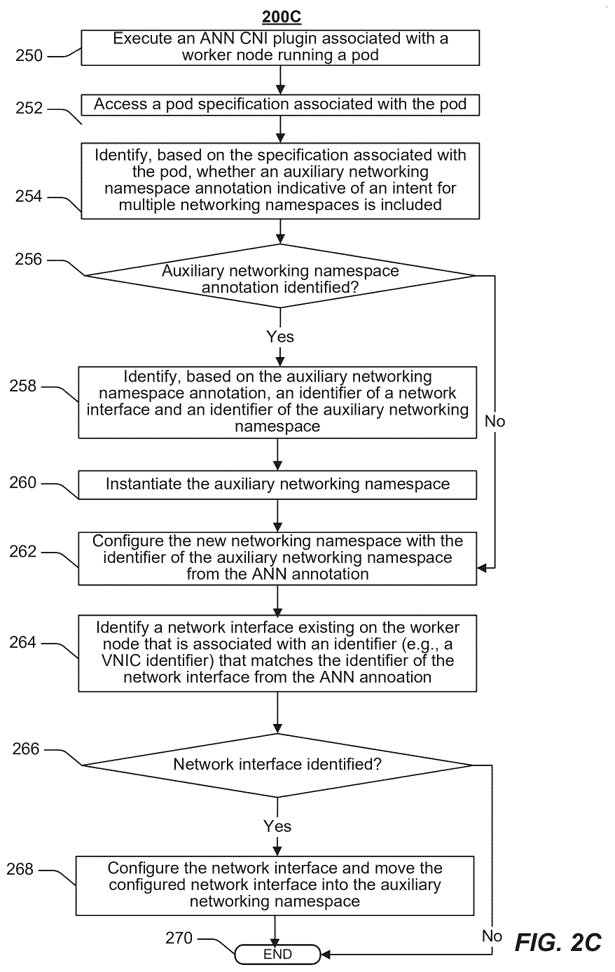

FIG. 2A illustrates a schematic diagram 200A of a Kubernetes pod executing on a worker node 202 including a first container 218 within a default network namespace 222 and a second container 220 within an auxiliary network namespace 224, in accordance with one or more embodiments of the present disclosure. For example, as depicted, the schematic diagram 200 may include a worker node 202, a service network 204, a managed Kubernetes network 206, and an external customer network 208. It should be appreciated that the schematic diagram 200A may represent only one example embodiment of the present disclosure. For example, in other embodiments, the schematic diagram 200A of the Kubernetes pod may not include the service network 204 and service interface 210, and thus the single the logical unit 216 (e.g., Kubernetes pod), in accordance with the presently disclosed embodiments, may allow interconnection to any type of Kubernetes cluster.

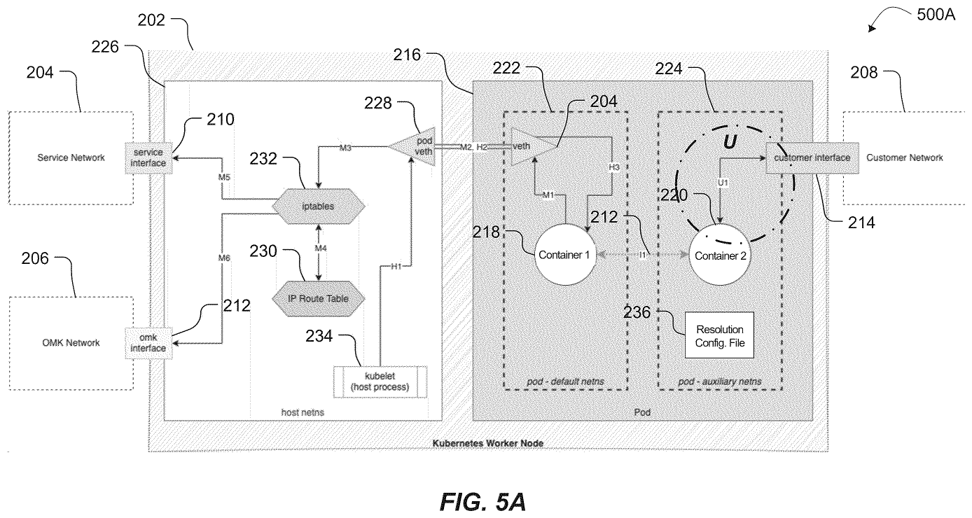

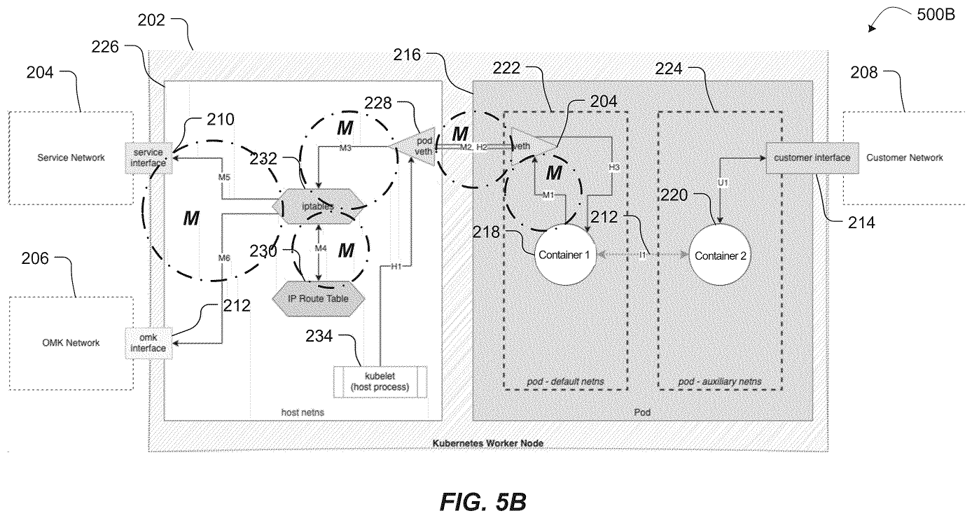

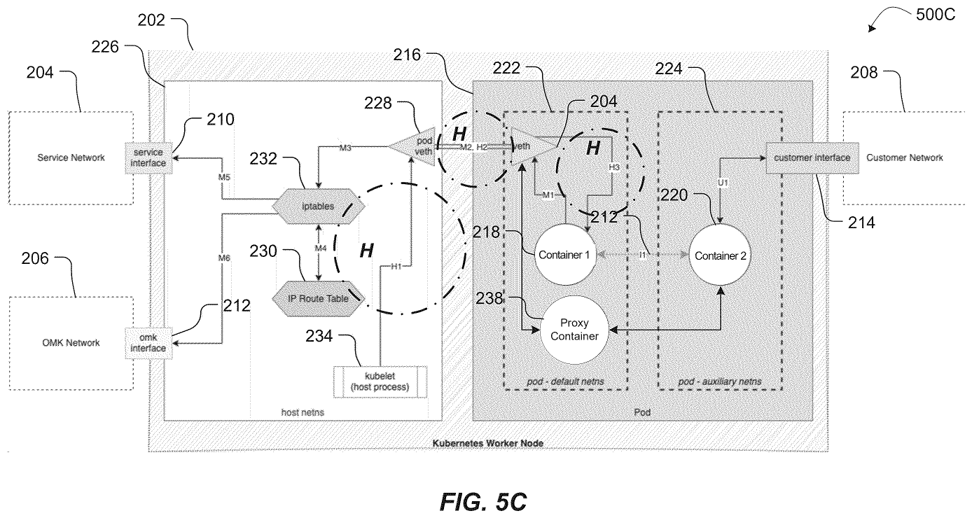

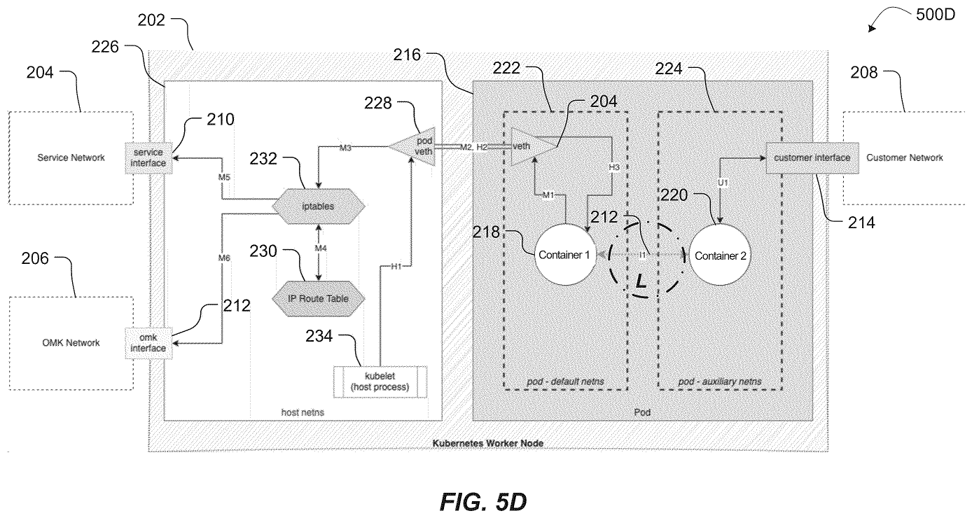

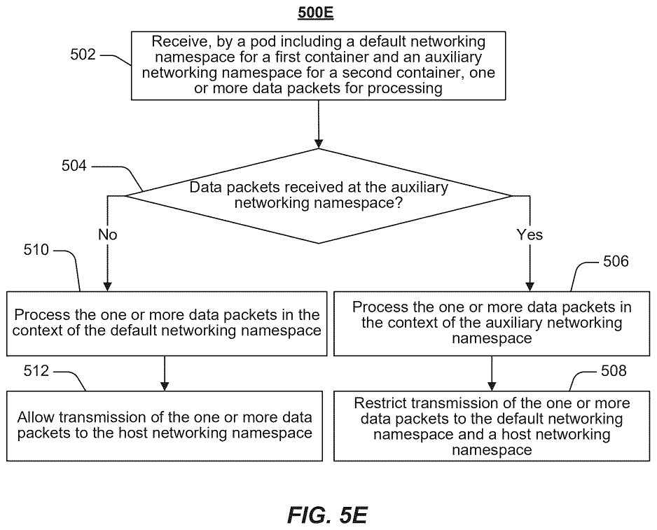

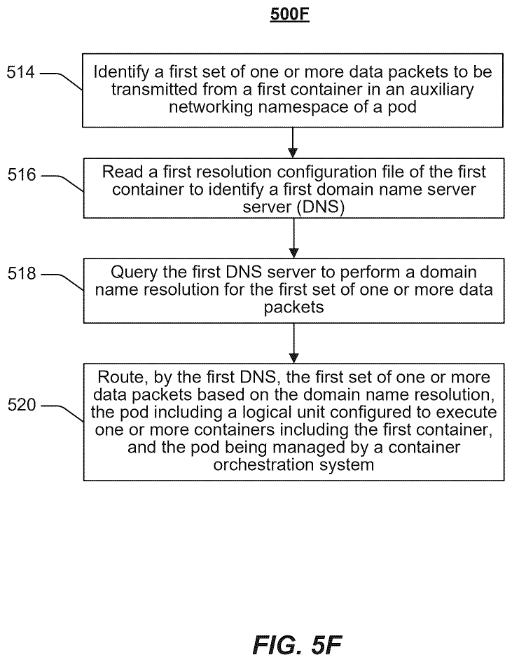

In particular embodiments, as generally discussed above with respect to FIG. 1B, the worker node 202 may be one computing node of a Kubernetes cluster of nodes (e.g., physical or virtual machines running containerized applications). In particular embodiments, the worker node 202 may connected to the service network 204 via a service interface 210, connected to the managed Kubernetes network 206 via a managed Kubernetes interface 212, and connected to the external customer network 208 via an external customer network interface 214. In particular embodiments, as further illustrated, the worker node 202 may include a logical unit 216 (e.g., Kubernetes pod) that may be utilized to execute a first container 218 and a second container 220 for hosting, for example, a containerized application associated with one or more of the service network 204, the managed Kubernetes network 206, or the external customer network 208. As will be further discussed below with respect to FIGS. 5A-5F, the worker node 202 may also include a host network namespace 226, which may be suitable for connecting the managed Kubernetes interface 212 and the customer network interface 214 via one or more host processes 234, one or more routing tables (IP route table 230 and IP tables 232) and virtual ethernet device pair (veths) 225, 228 to the containers 218, 220 executing on the Kubernetes pod, and, by extension, to the external customer network interface 214.

As further depicted, in accordance with the presently disclosed embodiments, the logical unit 216 (e.g., Kubernetes pod) may include a default network namespace 222 for the first container 218 and a separate and distinct auxiliary network namespace 224 for the second container 220. In contrast to conventional logical Kubernetes pod architectures in which all containers 218, 220 within a single logical unit 216 (e.g., Kubernetes pod) may share the same network namespace, the presently disclosed embodiments provide separate and distinct network namespaces (e.g., default network namespace 222 and auxiliary network namespace 224) within the single the logical unit 216 (e.g., Kubernetes pod).

In this way, different network interfaces (e.g., service interface 210, managed Kubernetes interface 212, and external customer network interface 214) may be isolated and connected to different network namespaces. For example, as further depicted, the service interface 210 and the managed Kubernetes interface 212 may be connected to the default network namespace 222 and the external customer network interface 214 may be connected to the auxiliary network namespace 224, such that the service interface 210 and the managed Kubernetes interface 212 may be isolated from the external customer network interface 214. Specifically, by providing separate and distinct network namespaces (e.g., pod default network namespace 222 and pod auxiliary network namespace 224) within the single the logical unit 216 (e.g., Kubernetes pod), the present embodiments may further provide a secure execution context for the respective first container 218 and the second container 220 within the logical unit 216 (e.g., Kubernetes pod).

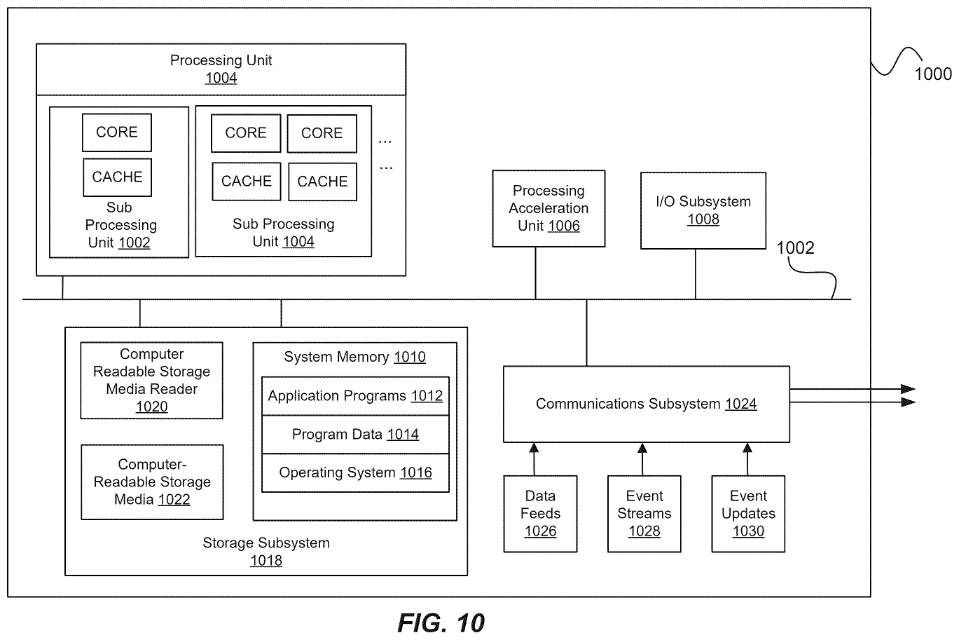

FIG. 2B illustrates a flowchart of a method 200B for receiving a user request to create a network interface custom resource within an auxiliary network namespace and creating the customer network interface within the auxiliary network namespace, in accordance with one or more embodiments of the present disclosure. The method 200B may be performed during creation of a pod having an auxiliary network namespace. The method 200B may be performed by the computer system 1000 as described below with respect to FIG. 10. The method 200B may begin at block 240 with a processor (e.g., processing unit 1004) receiving a first user request to create a network interface custom resource (e.g., external customer network interface 214 of FIG. 2A), in which the first user request specifies (1) an identifier of the network interface (e.g., external customer network interface 214) and (2) an identifier of a network namespace (e.g., auxiliary network namespace 224 of FIG. 2A) for the network interface.

The method 200B may continue at block 242 with the processor instantiating a network interface within a VCN based on the user request to create the network interface custom resource. The method 200B may continue at block 244 with the processor receiving a second user request to create a network interface annotation (e.g., one or more annotations 114 of FIG. 1A) on a pod (e.g., Kubernetes pod 128A of FIG. 1A or logical unit 216 of FIG. 2A) for associating the pod with the network interface, the second user request specifying an identifier of the network interface.

The method 200B may continue at block 246 with the processor creating the network interface annotation for the pod. The method 200B may then conclude at block 248 with the processor creating an auxiliary network attachment annotation for the pod based on the network interface annotation, in which the auxiliary network attachment annotation specifies (1) an identifier of the network interface and (2) an identifier of a network namespace for the network interface.

FIG. 2C illustrates a flowchart of a method 200C for executing CNI plugin that accesses and searches a pod specification, locates pod annotations, and instantiates and configures an auxiliary network namespace, in accordance with one or more embodiments of the present disclosure. The method 200C may be performed during creation of a pod having an auxiliary network namespace. The method 200C may be performed by the computer system 1000 as described below with respect to FIG. 10. The method 200C may begin at block 250 with a processor (e.g., processing unit 1004) executing an ANN CNI plugin (e.g., plugin 130A of FIG. 1B) associated with a worker node running a pod (e.g., Kubernetes pod 128A of FIG. 1A or logical unit 216 of FIG. 2A).

The method 200C may continue at block 252 with the processor accessing a pod specification (e.g., pod specification 112 of FIG. 1A) associated with the pod. The method 200C may then continue at block 254 with a processor identifying, based on the specification associated with the pod, whether an auxiliary network namespace annotation (e.g., ANN annotation 116A of FIG. 1A) indicative of an intent for multiple network namespaces (e.g., default network namespace 222 and auxiliary network namespace 224) is included. The method 200C may then continue at decision 256 with the processor confirming whether the ANN annotation has been identified.

In particular embodiments, in response to confirming that the ANN annotation has not been identified (see decision block 256), the method 200C advances to block 270, where the method 200C ends. On the other hand, in response to confirming that the ANN annotation has been identified (see decision block 256), the method 200C may then continue at block 258 with the processor identifying an interface (e.g., external customer network interface 214 of FIG. 2A) existing on the worker node (e.g., worker node 118 if FIG. 1B or worker node 202 of FIG. 2A) including a virtual network interface card (VNIC) identification that matches to the identified identifier of the network interface. The method 200C may then continue to block 260, where the processor instantiates the auxiliary network namespace. At block 262 of method 200C, the processor configures the new network namespace with the identifier of the auxiliary network namespace from the ANN annotation. The method 200C may then continue to block 264, where the processor identifies a network interface existing on the worker node that is associated with an identifier (e.g., a VNIC identifier) that matches the identifier of the network interface from the ANN annotation. The method 200C may then continue at decision 266 with the processor confirming whether the network interface (e.g., external customer network interface 214) existing on the worker node (e.g., worker node 118, 202) has been identified.

In particular embodiments, in response to confirming that the network interface existing on the worker has not been identified (see decision block 264), the method 200C advances to block 270, where the method 200C ends. On the other hand, in response to confirming that the network interface existing on the worker node has been identified (see decision block 264), the method 200C may then proceed to block 268 with the processor configuring the network interface and moving the configured network interface into the auxiliary network namespace (e.g., auxiliary network namespace 132B of FIG. 1B or 224 of FIG. 2A). Method 200C then moves from block 268 to block 270, where method 200C ends.

Particular embodiments may repeat one or more steps of the method of FIG. 2B and the method of FIG. 2C, where appropriate. Although this disclosure describes and illustrates particular steps of the method of FIG. 2B and the method of FIG. 2C as occurring in a particular order, this disclosure contemplates any suitable steps of the method of FIG. 2B and the method of FIG. 2C occurring in any suitable order. Moreover, although this disclosure describes and illustrates an example method for instantiating distinct network namespaces for each container within a pod including the particular steps of the method of FIG. 2B and the method of FIG. 2C, this disclosure contemplates any suitable method for instantiating distinct network namespaces for each container within a pod including any suitable steps, which may include all, some, or none of the steps of the method of FIG. 2B and the method of FIG. 2C, where appropriate. Furthermore, although this disclosure describes and illustrates particular components, devices, or systems carrying out particular steps of the method of FIG. 2B and the method of FIG. 2C, this disclosure contemplates any suitable combination of any suitable components, devices, or systems carrying out any suitable steps of the method of FIG. 2B and the method of FIG. 2C.

### 4. Instantiating and Configuring a Container within a Context of an Auxiliary Network Namespace of a Pod

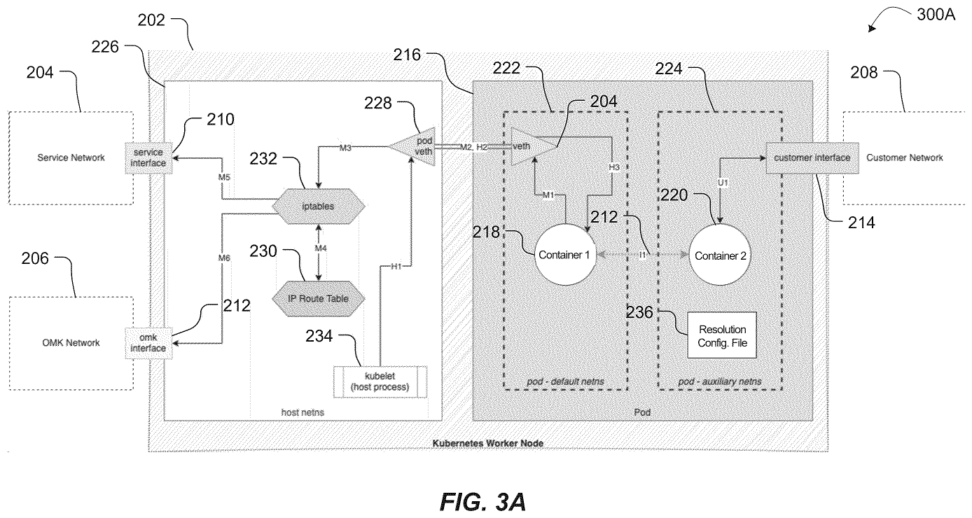

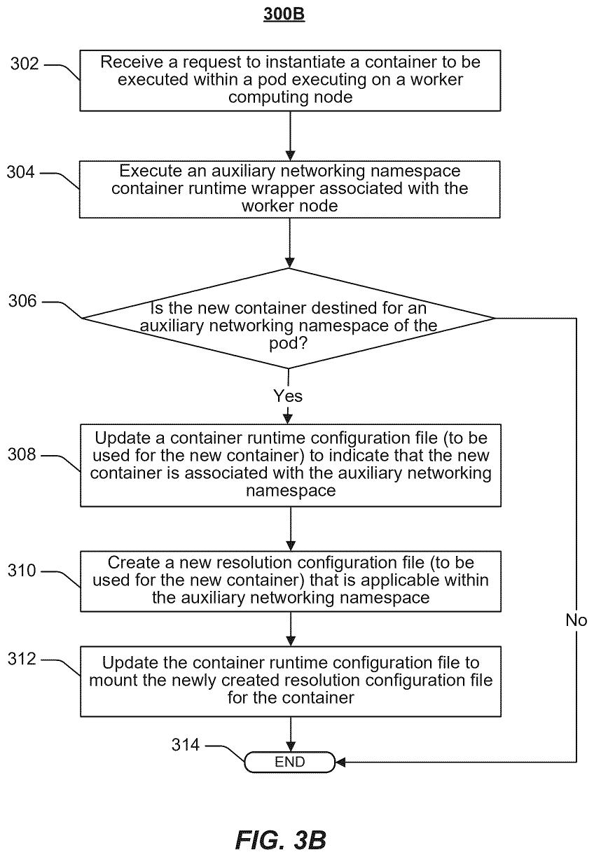

FIG. 3A illustrates a schematic diagram 300A of a Kubernetes pod executing on a worker node 202 including a first container 218 within a default network namespace 222 and a second container 220 within an auxiliary network namespace 224 and a resolution configuration file 236 that executes within the auxiliary network namespace 224, in accordance with one or more embodiments of the present disclosure. For example, in particular embodiments, at container 218, 220 instantiation time, the worker node (e.g., worker node 118 of FIG. 1A or 202 of FIG. 3A) may receive a “create container” call. In particular embodiments, in response to the “create container” call, the worker node (e.g., worker node 118 of FIG. 1B or 202) may then execute a container runtime wrapper. For example, in particular embodiments, the container runtime wrapper 133 of FIG. 1A may first determine that the “create container” call has been received and that the second container 220 being instantiated is destined for the auxiliary network namespace 224 of the Kubernetes pod.

In particular embodiments, based on the determination that the “create container” call has been received and that the second container 220 being instantiated is destined for the auxiliary network namespace 224, the container runtime wrapper 133 may then update the container runtime configuration file 126 of FIG. 1A, which is to be utilized by the second container 220 being instantiated. For example, the container runtime wrapper 133 may then update the container runtime configuration file 126 to replace the default network namespace 222 with the auxiliary network namespace 224 into which the second container 220 is being instantiated. In this way, a new resolution configuration file 236, which is to be utilized by the second container 220, is created and executes within the auxiliary network namespace 224. In particular embodiments, the container runtime wrapper 133 may then further update the container runtime configuration file 126 to mount the updated resolution configuration file 236 in place of any existing resolution configuration file.

FIG. 3B illustrates a flowchart of a method 300B for executing a container runtime wrapper to instantiate and configure a container to be within an auxiliary network namespace, in accordance with one or more embodiments of the present disclosure. The method 300B may be performed during creation of a container in a pod having an auxiliary network namespace. The method 300B may be performed by the computer system 1000 as described below with respect to FIG. 10. The method 300B may begin at block 302 with a processor (e.g., processing unit 1004) receiving a request to instantiate a container 218, 220 to be executed within a pod (e.g., Kubernetes pod) executing on a worker node (e.g., worker node 118 of FIG. 1B or 202 of FIG. 3A). The method 300B may continue at block 304 with the processor executing an auxiliary network namespace container runtime wrapper (e.g., auxiliary namespace container runtime wrapper 133A of FIG. 1B) to instantiate a second container (e.g., container 220 of FIG. 3A) to be executed within the pod (e.g., Kubernetes pod).

The method 300B may then continue at block 306 with the processor determining whether the new container is not destined for an auxiliary network namespace of the pod, then method 300B advances to block 314, where method 300B ends. If, at block 306, the new container is destined for an auxiliary network namespace of the pod, then method 300B continues on to block 308, where the processor updates a container runtime configuration file (e.g., container runtime configuration file 126 of FIG. 1B) to include the auxiliary network namespace (e.g., auxiliary network namespace 224 of FIG. 3A), in which the update includes a replacement of a default network namespace (e.g., default network namespace 222 of FIG. 3A) of the pod with the auxiliary network namespace (e.g., auxiliary network namespace 224 of FIG. 3A). The method 300B may then continue at block 310 with the processor creating a new resolution configuration file (e.g., resolution configuration file 236 of FIG. 3A) that executes within the auxiliary network namespace. The method 300B may then continue to block 312 with the processor updating the container runtime configuration file to include the identified new resolution configuration file.

Particular embodiments may repeat one or more steps of the method of FIG. 3B, where appropriate. Although this disclosure describes and illustrates particular steps of the method of FIG. 3B as occurring in a particular order, this disclosure contemplates any suitable steps of the method of FIG. 3B occurring in any suitable order. Moreover, although this disclosure describes and illustrates an example method for instantiating distinct network namespaces for each container within a pod including the particular steps of the method of FIG. 3B, this disclosure contemplates any suitable method for instantiating distinct network namespaces for each container within a pod including any suitable steps, which may include all, some, or none of the steps of the method of FIG. 3B, where appropriate. Furthermore, although this disclosure describes and illustrates particular components, devices, or systems carrying out particular steps of the method of FIG. 3B, this disclosure contemplates any suitable combination of any suitable components, devices, or systems carrying out any suitable steps of the method of FIG. 3B.

### 5. Performing Health Checks of Respective Containers Instantiated within an Auxiliary Network Namespace of a Pod

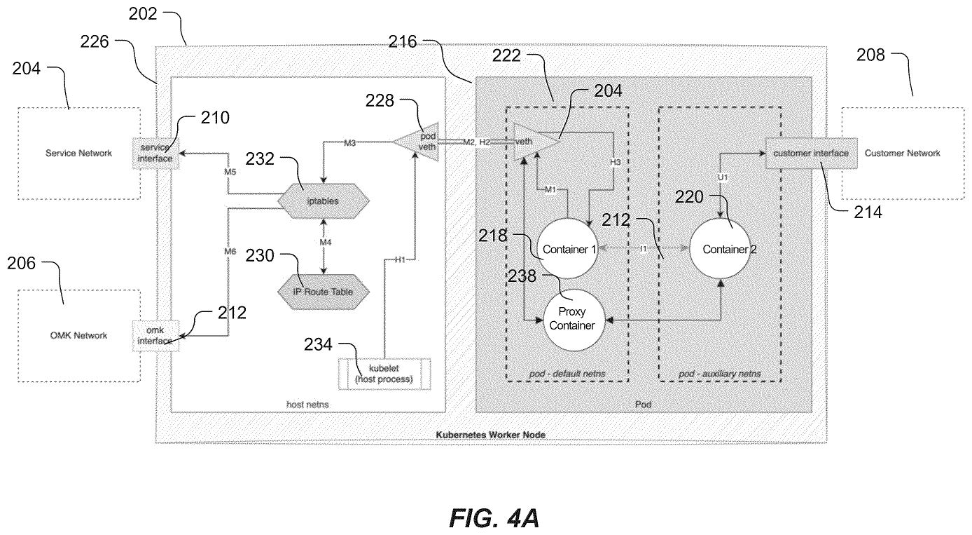

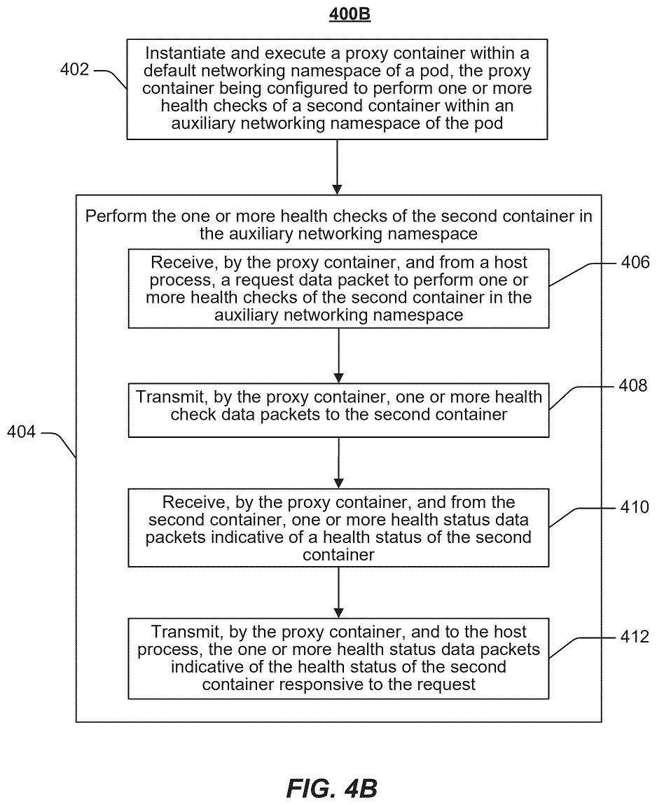

FIG. 4A illustrates a schematic diagram 400A of a proxy container 238 that is instantiated and executed within a default network namespace 222 of the Kubernetes pod for performing health checks of a respective second container 220 instantiated and executed within an auxiliary network namespace 224 of the Kubernetes pod, in accordance with one or more embodiments of the present disclosure. As depicted by FIG. 4A, in particular embodiments, a proxy container 238 may be instantiated within the default network namespace 222. For example, in accordance with the presently disclosed embodiments, the proxy container 238 may be utilized to perform one or more health checks of the second container 220 executing within the auxiliary network namespace 224. In particular embodiments, the proxy container 238 may receive a request to perform one or more health checks of the second container 220 within the auxiliary network namespace 224. For example, in one embodiment, the proxy container 238 may receive the request to perform one or more health checks of the second container 220 from a host process 234 executing within the host network namespace 226 executing on the worker node 202.

In particular embodiments, the proxy container 238 may then transmit the request to perform the one or more health checks to the second container 220 executing within the auxiliary network namespace 224. In particular embodiments, the proxy container 238 may then receive from the second container 220 an indication of a health status of the second container 220 via the one or more dedicated communications protocols established between default network namespace 222 and the auxiliary network namespace 224. In particular embodiments, the proxy container 238 may then transmit the indication of a health status of the second container 220 to the host process 234 executing within the host network namespace 226 to satisfy the initial request.

It should be appreciated that—without the presently disclosed embodiments—any TCP/HTTP based health checks (e.g., liveness checks, readiness checks, etc.) configured on the second container 220 executing within the auxiliary network namespace 224 would not be executable, as conventional Kubernetes pod architecture may be aware of only the internet protocol (IP) address of the logical unit 216 (e.g., Kubernetes pod) corresponding, for example, to the default network namespace 222. Hence, this IP address would not correspond to an IP address associated with the auxiliary network namespace 224, and so the host process 234 executing within the host network namespace 226 would otherwise not be able to communicate with the second container 220 executing within the auxiliary network namespace 224 without the presently disclosed embodiments.

Specifically, in accordance with the presently disclosed embodiments, a set of one-to-one mappings may exist between the proxy container 238 (or one or more additional proxy containers 238) executing within the default network namespace 222 and the container(s) 220 executing within the auxiliary network namespace 224. Thus, the present embodiments allow for the proxy container 238 instantiated and executed within the default network namespace 222 to perform one or more health checks of the second container 220 executing within the auxiliary network namespace 224.

FIG. 4B illustrates a flowchart of a method 400B for instantiating a proxy container within a default network namespace, and further executing the proxy container to perform one or more health checks on a container within an auxiliary network namespace, in accordance with one or more embodiments of the present disclosure. The method 400B may be performed by the computer system 1000 as described below with respect to FIG. 10. The method 400B may begin at block 402 with a processor (e.g., processing unit 1004) instantiating and executing a proxy container (e.g., proxy container 238 of FIG. 4A) within a default network namespace (e.g., default network namespace 222 of FIG. 4A) of a pod (e.g., Kubernetes pod), in which the proxy container is configured to perform one or more health checks of a second container (e.g., second container 220 of FIG. 4A) within an auxiliary network namespace (e.g., auxiliary network namespace 224 of FIG. 4A) of the pod (e.g., Kubernetes pod).

The method 400B may continue at block 404 with the processor performing the one or more health checks of the second container executing within the auxiliary network namespace. For example, performing the one or more health checks of the second container may include the method 400B continuing at block 406 with the processor receiving, by the proxy container, and from a host process (e.g., host process 234 of FIG. 4B executing within the host network namespace 226 of FIG. 4B), a request data packet to perform one or more health checks of the second container executing within the auxiliary network namespace.

In particular embodiments, performing the one or more health checks of the second container further includes the method 400B continuing at block 408 with the processor transmitting, by the proxy container, one or more health check data packets to the second container. Performing the one or more health checks of the second container further includes the method 400B continuing at block 410 with the processor receiving, by the proxy container, and from the second container, one or more health status data packets indicative of a health status of the second container.

In particular embodiments, performing the one or more health checks of the second container concludes with the method 400B at block 412 with the processor transmitting, by the proxy container, and to the host process, the one or more health status data packets indicative of the health status of the second container responsive to the request.

Particular embodiments may repeat one or more steps of the method of FIG. 4B, where appropriate. Although this disclosure describes and illustrates particular steps of the method of FIG. 4B as occurring in a particular order, this disclosure contemplates any suitable steps of the method of FIG. 4B occurring in any suitable order. Moreover, although this disclosure describes and illustrates an example method for performing one or more health checks of a container within an auxiliary network namespace of a pod including the particular steps of the method of FIG. 4B, this disclosure contemplates any suitable method for performing one or more health checks of a container within an auxiliary network namespace of a pod including any suitable steps, which may include all, some, or none of the steps of the method of FIG. 4B, where appropriate. Furthermore, although this disclosure describes and illustrates particular components, devices, or systems carrying out particular steps of the method of FIG. 4B, this disclosure contemplates any suitable combination of any suitable components, devices, or systems carrying out any suitable steps of the method of FIG. 4B.

### 6. Handling Various Routings of Data Packets Associated with a Pod Including Containers within a Default Network Namespace and a Auxiliary Network Namespace

FIGS. 5A-5D illustrate schematic diagrams 500A, 500B, 500C, and 500D of a Kubernetes pod, in which data packets are routed to and from containers 218, 220 executing within the default network namespace 222 and the auxiliary network namespace 224, respectively, in accordance with one or more embodiments of the present disclosure. It should be appreciated that the schematic diagram 500A may represent only one example embodiment of the present disclosure. For example, in other embodiments, the schematic diagram 500A of the Kubernetes pod may not include the service network 204 and service interface 210, and thus the single the logical unit 216 (e.g., Kubernetes pod), in accordance with the presently disclosed embodiments, may allow interconnection to any type of Kubernetes cluster.

In particular embodiments, referring first to the schematic diagram 500A of FIG. 5A, second container 220 in auxiliary network namespace 224 has a packet to send to the external customer network 208. The logical unit 216 (e.g., Kubernetes pod) reads the resolution configuration file 236 of the second container 220 to determine an appropriate DNS to query. Based on the DNS resolution, the packet is routed to an auxiliary network attachment (e.g., the external customer network interface 214) that is located between the auxiliary network namespace 224 and the external customer network 208, without going through the host network namespace 226. The data packet reception and transmission routes between the second container 220 and the external customer network interface 214 are illustrated by arrow U1 located within dashed circle “U” as depicted by FIG. 5A.

In certain embodiments, any data packets that are received via the external customer network interface 214 are processed in the context of the auxiliary network namespace 224. The data packets received by the second container 220 may be restricted from being transmitted to the default network namespace 222 and the host network namespace 226.

While the data packets received by the second container 220 are restricted from being transmitted to the default network namespace 222 and the host network namespace 226, in some embodiments, the first container 218 executing within the default network namespace 222 may communicate with the second container 220 in the auxiliary network namespace 224 via one or more communications protocols not including a transmission control protocol/internet protocol (TCP/IP). For example, in the embodiment of FIG. 5D, the second container 220 in the auxiliary network namespace 224 has a packet to send to the default network namespace 222. The packet can be sent via any non-TCP/IP method. For instance, inter-process communication (IPC) sockets (e.g., a Unix Domain Socket) may be used. An example of the data packet reception and transmission routes between the first container 218 executing within the default network namespace 222 and the second container 220 executing within the auxiliary network namespace 224 are illustrated by arrow l1 located within dashed circle “L” as depicted by FIG. 5D.

In certain embodiments, packets from containers in the auxiliary network namespace 224 cannot be sent anywhere other than to the external customer network interface 214, since there are no other attachments, interfaces, or sockets. In some embodiments, the second container 220 executing within the auxiliary network namespace 224 may communicate via shared files existing in the worker node 202.

FIG. 5B illustrates example schematic diagram 500B depicting data packet reception and transmission routes between the first container 218 executing within the default network namespace 222 and the host process 234 executing within the host network namespace 226, as illustrated by arrows M1, M2, M3, M4, M5, and M6 located within dashed circles “M”. In the schematic diagram 500B, the first container 218 in the default network namespace 222 has a packet to send to the host network namespace 226. When data packets are received by the first container 218, since the first container 218 is executing within the default network namespace 222, the data packets are processed in the context of the default network namespace 222. The data packets are transmitted (see arrow M1) to a virtual ethernet device (veth) pair located between the default network namespace 222 and the host network namespace 226. In particular embodiments, the veth pair includes two virtual interfaces 225, 228, in which the veth 225 is assigned to the default network namespace 222 and the pod veth 228 is assigned to the host network namespace 226. The veth 225 and the pod veth 228 allow traffic to flow (see arrow M2) between the default network namespace 222 and the host network namespace 226. In accordance with presently disclosed embodiments, each of the default network namespace 222, the auxiliary network namespace 224, and the host network namespace 226 may include its own network stack (e.g., its own IP tables 230, 232, firewall rules, network devices, etc.). For example, as illustrated in schematic diagram 500B, the pod veth 228 may communicate (see arrow M3) the data packets to IP tables 232 and/or IP route table 230. IP tables 232 and IP route table 230 may communicate (see arrow M4) with each other. IP table 232 may then communicate data packets to service interface 210 (see arrow M5) and/or the managed Kubernetes interface 212 (see arrow M6).

FIG. 5C illustrates a schematic diagram 500C of packets communicated from processes on the host network namespace 226, in accordance with certain embodiments. An example of the data packet reception and transmission routes between the host process 234 executing within the host network namespace 226 and the first container 218 executing within the default network namespace 222 are illustrated by arrows H1, H2, and H3 located within dashed circles “H” as depicted by FIG. 5C.

A process in the host network namespace 226 (e.g., default Linux namespace) has a packet to send to a default network namespace 222. The packet is routed to the pod veth 228 (see arrow H1) and then to veth 225 (see arrow H2), which are both located between the default network namespace 222 and the host network namespace 226. The pod veth 228 and the veth 225 allow traffic to flow between the default network namespace 222 and the host network namespace 226. The packet is then routed (see arrow H3) from veth 225 to the first container 218. In certain embodiments, host processes are not aware of the auxiliary network namespace 224 and hence would not have any packets destined for the auxiliary network namespace 224.

In certain embodiments, when data packets are received at the host process 234 executing within the host network namespace 226, the data packets may be processed within the host network namespace 226. For example, in particular embodiments, as previously discussed above with respect FIGS. 4A and 4B, the host process 234 executing within the host network namespace 226 may be generally unaware of the second container 220 executing within the auxiliary network namespace 224. Thus, the host process 234 executing within the host network namespace 226 may route data packets only to the first container 218 executing within the default network namespace 222.

FIG. 5C further illustrates a schematic diagram 500C of the handling of container probes for containers in the auxiliary network namespace 224, in accordance with certain embodiments. For example, a processor (e.g., processing unit 1004) may create the proxy container 238 in the default network namespace 222 for each container in the auxiliary network namespace 224. For each health check (see, e.g., FIGS. 4A and 4B), a process in the host network namespace 226 desires to perform a health check for a container (e.g., second container 220) in the auxiliary network namespace 224. The host process generates a check packet to send to the proxy container 238 that was created in the default network namespace 222. The proxy container 238 communicates the check packet to the corresponding second container 220 in the auxiliary network namespace 224. The second container 220 in the auxiliary network namespace 224 communicates a success packet to the proxy container 238. If the proxy container 238 receives the success packet from the second container 220 in the auxiliary network namespace 224, the proxy container 238 communicates a success packet to the host process.

FIG. 5E illustrates a flowchart of a method 500E for receiving data packets and routing the data packets based on whether the data packets are received at an auxiliary network namespace of a pod, in accordance with one or more embodiments of the present disclosure. The method 500E may be performed by the computer system 1000 as described below with respect to FIG. 10. The method 500E may begin at block 502 with a processor (e.g., processing unit 1004) receiving, by a pod (e.g., Kubernetes pod) including a default network namespace (e.g., default network namespace 222) for a first container (e.g., first container 218) and an auxiliary network namespace (e.g., auxiliary network namespace 224) for a second container (e.g., second container 220), one or more data packets for processing.

In particular embodiments, the method 500E may continue at decision 504 with the processor (e.g., processing unit 1004) determining whether the one or more data packets are received at the auxiliary network namespace (e.g., auxiliary network namespace 224). In particular embodiments, in response to determining that the one or more data packets are received at the auxiliary network namespace (e.g., auxiliary network namespace 224) (e.g., at decision 504), the method 500E may continue at block 506 with the processor (e.g., processing unit 1004) processing the one or more data packets in the context of the auxiliary network namespace (e.g., auxiliary network namespace 224). The method 500E may then continue at block 508 with the processor (e.g., processing unit 1004) restricting transmission of the one or more data packets to the default network namespace 222 and the host network namespace 226. Additional details for blocks 506 and 508 are provided in FIG. 5A.

In particular embodiments, in response to determining that the one or more data packets are not received at the auxiliary network namespace (e.g., auxiliary network namespace 224) (e.g., at decision 504), the method 500E may continue at block 510 with the processor (e.g., processing unit 1004) processing the one or more data packets in the context of the default network namespace 222. The method 500E may then continue at block 512 with the processor (e.g., processing unit 1004) allowing transmission of the one or more data packets to the host network namespace 226. Additional details for blocks 510 and 512 are provided in FIGS. 5B-5D.

FIG. 5F illustrates a method 500F for transmitting one or more data packets from a container in an auxiliary network namespace of a pod, in accordance with one or more embodiments of the present disclosure. The method 500F may be performed by the computer system 1000 as described below with respect to FIG. 10. The method 500F may begin at block 514 with a processor (e.g., processing unit 1004) identifying a set of one or more data packets to be transmitted from a container (e.g., second container 220 of FIG. 5A) executing within an auxiliary network namespace (e.g., auxiliary network namespace 224) of a pod (e.g., Kubernetes pod).

The method 500F may continue at block 516 with the processor reading a resolution configuration file (e.g., resolution configuration file 236 of FIG. 5A) of the container (e.g., second container 220 of FIG. 5A) to identify a DNS. The method 500F may continue at block 518 with the processor querying the DNS to perform a domain name resolution for the set of one or more data packets. The method 500F may then conclude at block 520 with the processor routing, by the DNS, the set of one or more data packets based on the domain name resolution, in which the pod (e.g., Kubernetes pod) includes a logical unit configured to execute one or more containers (e.g., first container 218, second container 220 of FIG. 5A) including the container (second container 220 of FIG. 5A), and the pod is managed by a container orchestration system. Additional details of method 500F are provided in FIG. 5A.

Particular embodiments may repeat one or more steps of the method 500E of FIG. 5E or the method 500F of FIG. 5F, where appropriate. Although this disclosure describes and illustrates particular steps of the method 500E of FIG. 5E and the method 500F of FIG. 5F as occurring in a particular order, this disclosure contemplates any suitable steps of the method 500E of FIG. 5E and the method 500F of FIG. 5F occurring in any suitable order. Moreover, although this disclosure describes and illustrates an example method for transmitting, receiving, and processing data packets across distinct network namespaces for each container within a pod including the particular steps of method 500E of FIG. 5E and the method 500F of FIG. 5F, this disclosure contemplates any suitable method for transmitting, receiving, and processing data packets across distinct network namespaces for each container within a pod including any suitable steps, which may include all, some, or none of the steps of method 500E of FIG. 5E and the method 500F of FIG. 5F, where appropriate. Furthermore, although this disclosure describes and illustrates particular components, devices, or systems carrying out particular steps of the method 500E of FIG. 5E and the method 500F of FIG. 5F, this disclosure contemplates any suitable combination of any suitable components, devices, or systems carrying out any suitable steps of the method 500E of FIG. 5E and the method 500F of FIG. 5F.

### 7. Service and Cloud Infrastructure

The embodiments disclosed herein may be utilized in infrastructure as a service (IaaS). Infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. IaaS deployment may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., which components are needed and how they interact) can be defined by one or more configuration files. Thus, the overall topology of the infrastructure (e.g., which resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

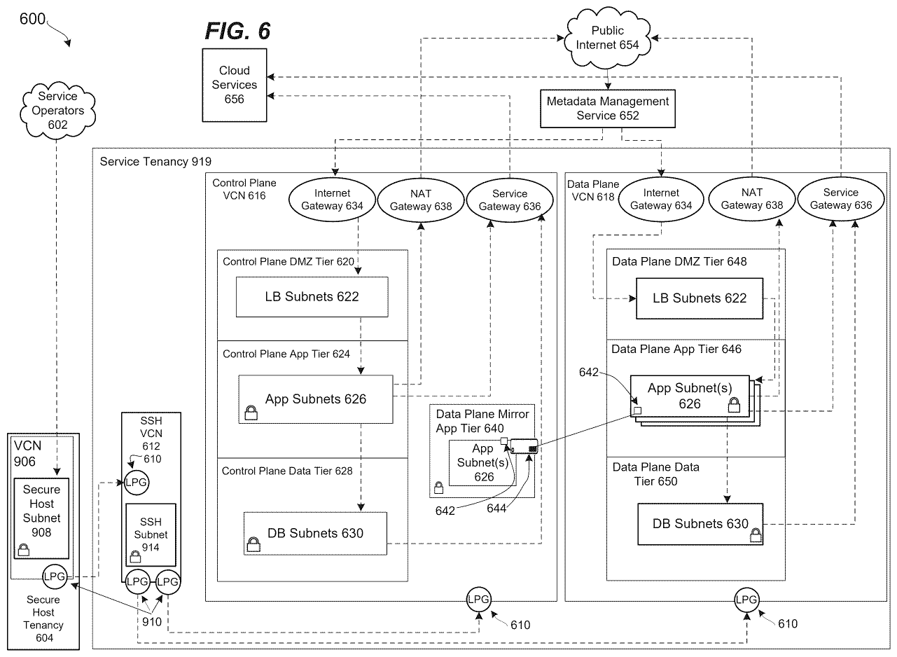

FIG. 6 is a block diagram 600 illustrating an example pattern of an IaaS architecture, according to at least one embodiment. Service operators 602 can be communicatively coupled to a secure host tenancy 604 that can include a VCN 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a VNIC 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively couple to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user (e.g., a customer) of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users from interacting with other users' resources. Also, this embodiment may allow users of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

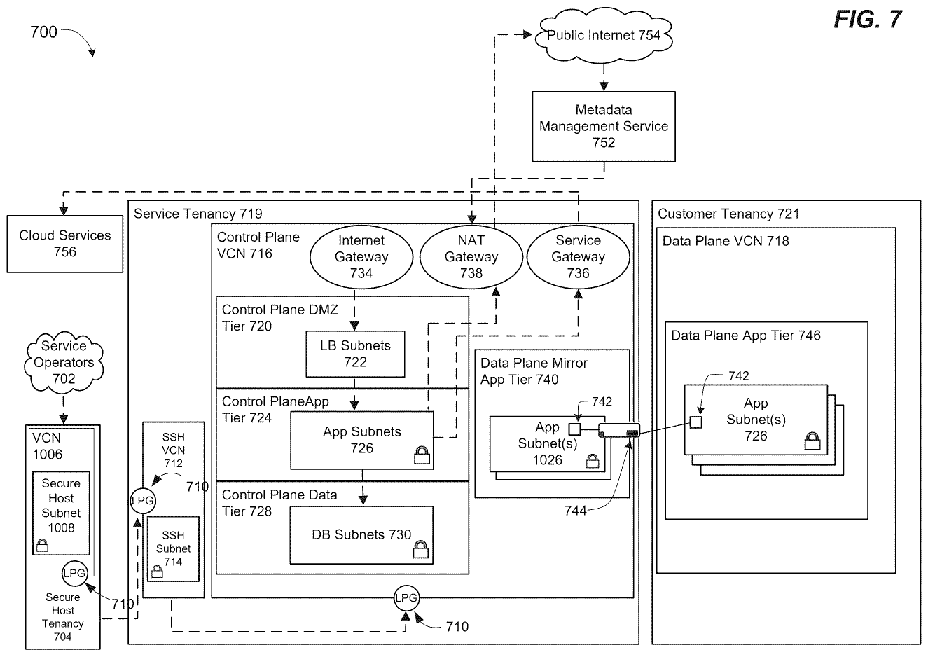

FIG. 7 is a block diagram 700 illustrating another pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a VCN 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 610 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 1019 (e.g., the service tenancy 619 of FIG. 6), and the data plane VCN 718 (e.g., the data plane VCN 618 of FIG. 6) can be contained in a customer tenancy 1021 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a VNIC 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively couple to cloud services 756 (e.g., cloud services 656 of FIG. 6).

In some examples, the data plane VCN 718 can be contained in the customer tenancy 1021. In this case, the IaaS provider may provide the control plane VCN 716 for each customer, and the IaaS provider may, for each customer, set up a unique compute instance 744 that is contained in the service tenancy 1019. Each compute instance 744 may allow communication between the control plane VCN 716, contained in the service tenancy 1019, and the data plane VCN 718 that is contained in the customer tenancy 1021. The compute instance 744 may allow resources, which are provisioned in the control plane VCN 716 that is contained in the service tenancy 1019, to be deployed or otherwise used in the data plane VCN 718 that is contained in the customer tenancy 1021.

In other examples, the customer of the IaaS provider may have databases that live in the customer tenancy 1021. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 1021, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 6,” may be located in Region 1 and in “Region 2.” If a call to Deployment 6 is made by the service gateway 736 contained in the control plane VCN 716 located in Region 1, the call may be transmitted to Deployment 6 in Region 1. In this example, the control plane VCN 716, or Deployment 6 in Region 1, may not be communicatively coupled to, or otherwise in communication with, Deployment 6 in Region 2.

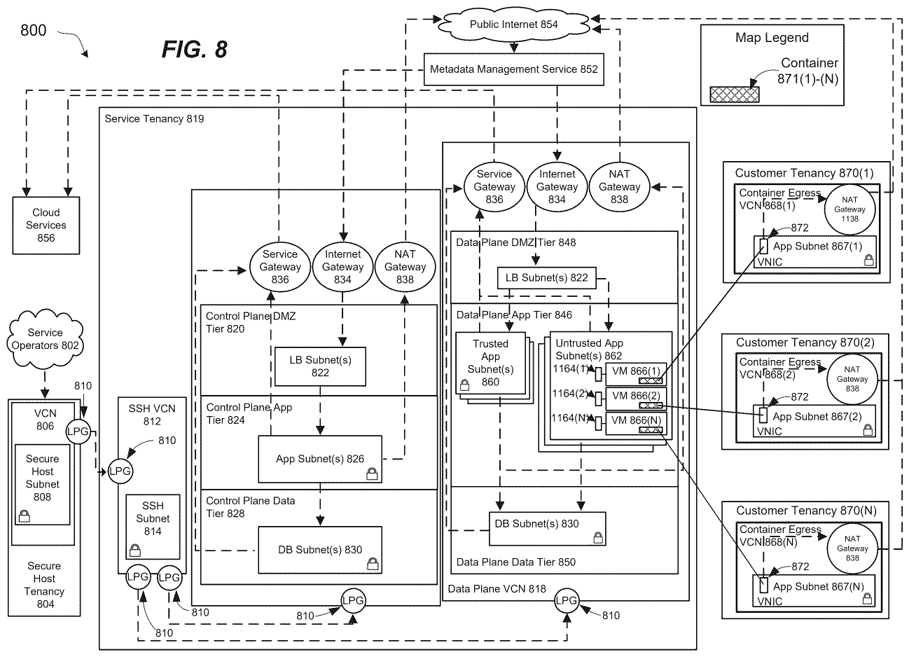

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a VCN 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane VCN 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management service 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other custom resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

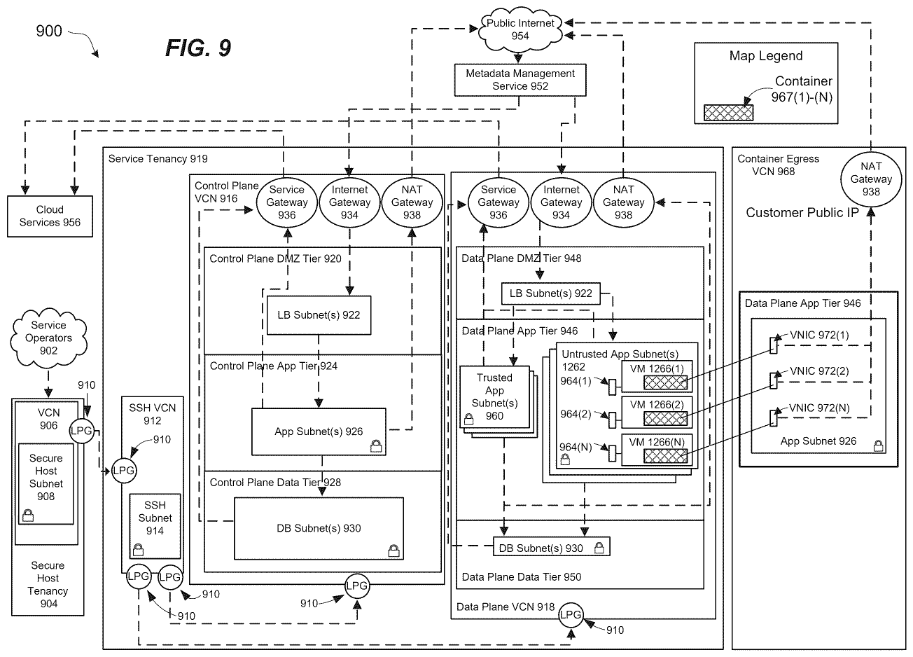

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a VCN 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 630 (e.g., DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management service 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 10 illustrates an example computer system 1000, in which various embodiments may be implemented. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processing unit(s) 1004 and/or in storage subsystem 1018. Through suitable programming, processing unit(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may include a storage subsystem 1018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1004 provide the functionality described above. Storage subsystem 1018 may also provide a repository for storing data used in accordance with the present disclosure.

As depicted in the example in FIG. 10, storage subsystem 1018 can include various components including a system memory 1010, computer-readable storage media 1022, and a computer readable storage media reader 1020. System memory 1010 may store program instructions that are loadable and executable by processing unit 1004. System memory 1010 may also store data that is used during the execution of the instructions and/or data that is generated during the execution of the program instructions. Various different kinds of programs may be loaded into system memory 1010 including but not limited to client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1010 may include a basic input/output system (BIOS) containing basic routines that help to transfer information between elements within computer system 1000, such as during start-up.

Computer-readable storage media 1022 may represent remote, local, fixed, and/or removable storage devices plus storage media for temporarily and/or more permanently containing, storing, computer-readable information for use by computer system 1000 including instructions executable by processing unit 1004 of computer system 1000.

Computer-readable storage media 1022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Machine-readable instructions executable by one or more processors or cores of processing unit 1004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments, communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. One or more computer-readable non-transitory storage media embodying software that is operable when executed to:
instantiate a first network namespace for a pod;
determine whether a pod specification includes an indication of an intent to create a second network namespace for the pod; and
responsive to determining that the pod specification includes the indication of the intent to create the second network namespace, instantiate the second network namespace for the pod;
wherein the pod comprises a logical unit configured to execute one or more containers, the pod being managed by a container orchestration system, and the pod specification comprising a file including one or more attributes of the pod.

2. The one or more computer-readable non-transitory storage media of claim 1, wherein each of the first network namespace and the second network namespace comprises its own network stack, including its own routing table, and wherein the first network namespace is a default network namespace and the second network namespace is an auxiliary network namespace.

3. The one or more computer-readable non-transitory storage media of claim 1, wherein instantiating the first network namespace and the second network namespace for the pod are performed during creation of the pod.

4. The one or more computer-readable non-transitory storage media of claim 1, wherein instantiating the first network namespace is executed based on a first container network interface (CNI) plugin, and wherein instantiating the second network namespace is executed based on a second CNI plugin.

5. The one or more computer-readable non-transitory storage media of claim 1, wherein a virtual ethernet pair (veth) interconnects the first network namespace and a host namespace of a host executing the pod.

6. The one or more computer-readable non-transitory storage media of claim 1, wherein an auxiliary network attachment interconnects the second network namespace and an external network.

7. The one or more computer-readable non-transitory storage media of claim 1, wherein an auxiliary network attachment interconnects the second network namespace and an external network without going through a host namespace of a host executing the pod.

8. The one or more computer-readable non-transitory storage media of claim 1, wherein a transmission control protocol/internet protocol (TCP/IP) connection does not connect the first network namespace and the second network namespace.

9. One or more computer-readable non-transitory storage media embodying software that is operable when executed to:
create a first set of domain name resolution settings for a container to be created in a pod, wherein the first set of domain name resolution settings are associated with a default network namespace of the pod;
determine whether the container is destined for an auxiliary network namespace of the pod; and
responsive to determining that the container is destined for the auxiliary network namespace of pod, associating the container with a second set of domain name resolution settings rather than the first set of domain name resolution settings, wherein the second set of domain name resolution settings are associated with the auxiliary network namespace;
wherein the pod comprises a logical unit configured to execute one or more containers including the container, the pod being managed by a container orchestration system.

10. The one or more computer-readable non-transitory storage media of claim 1, wherein associating the container with the second set of domain name resolution settings further comprises:
creating a new resolution configuration file including the second set of domain name resolution settings; and
updating a configuration file of the container to replace a first path to an existing resolution configuration file including the first set of domain resolution settings to a second path to the new resolution configuration file including the second set of domain resolution settings.

11. The one or more computer-readable non-transitory storage media of claim 9, wherein the second set of domain resolution settings indicates a domain name server (DNS) that is configured to perform a domain name resolution for an auxiliary network attachment interconnecting the auxiliary network namespace and an external network.

12. The one or more computer-readable non-transitory storage media of claim 9, wherein, subsequent to associating the container with the second set of domain name resolution settings, a domain name resolution for packets between the container and a second container in the default network namespace cannot be performed.

13. The one or more computer-readable non-transitory storage media of claim 9, wherein, subsequent to associating the container with the second set of domain name resolution settings, a domain name resolution for packets between the container and a host process executing on the host executing the pod cannot be performed.

14. A computing system, comprising:
one or more computer-readable non-transitory storage media embodying software; and
one or more processors coupled to the one or more computer-readable non-transitory storage media, the one or more processors configured to execute the software to:
instantiate a first network namespace for a pod;
determine whether a pod specification includes an indication of an intent to create a second network namespace for the pod; and
responsive to determining that the pod specification includes the indication of the intent to create the second network namespace, instantiate the second network namespace for the pod;
wherein the pod comprises a logical unit configured to execute one or more containers, the pod being managed by a container orchestration system, and the pod specification comprising a file including one or more attributes of the pod.

15. The computing system of claim 14, wherein each of the first network namespace and the second network namespace comprises its own network stack, including its own routing table, and wherein the first network namespace is a default network namespace and the second network namespace is an auxiliary network namespace.

16. The computing system of claim 14, wherein instantiating the first network namespace and the second network namespace for the pod are performed during creation of the pod.

17. The computing system of claim 14, wherein instantiating the first network namespace is executed based on a first container network interface (CNI) plugin and instantiating the second network namespace is executed based on a second CNI plugin.

18. The computing system of claim 14, wherein a virtual ethernet pair (veth) interconnects the first network namespace and a host namespace of a host executing the pod.

19. The computing system of claim 14, wherein an auxiliary network attachment interconnects the second network namespace and an external network.

20. The computing system of claim 14, wherein an auxiliary network attachment interconnects the second network namespace and an external network without going through a host namespace of a host executing the pod.

21. The computing system of claim 14, wherein a transmission control protocol/internet protocol (TCP/IP) connection does not connect the first network namespace and the second network namespace.
